(19) United States
(12) Patent Application Publication
(10) Pub. No.: US 2010/0240573 A1
(43) Pub. Date: Sep. 23, 2010

(54) SPRAY-BASED DEGREASING FLUID

(76) Inventors: Bernard K. Zysman, Amherst, NY (US); Gregory E. Robinson, Tonawanda, NY (US)

Correspondence Address: Vincent G. LoTempio, Suite 1002, 69 Delaware Avenue, Buffalo, NY, 14202, US

(21) Appl. No.: 12/729,135

(22) Filed: Mar. 22, 2010

Related U.S. Application Data
(60) Provisional application No. 61/161,863, filed on Mar. 20, 2009.

(51) Int. Cl. C11D 3/24

(52) U.S. Cl. 510/365

(57) ABSTRACT

Disclosed is a composition for degreasing surfaces comprising about 97.4 to 100% by volume parachlorobenzotrifluoride and 0 to about 2.6% by volume of a masking agent. Further provided is a method for degreasing surfaces comprising the above composition and providing a spray application means for applying the composition.

This application claims priority of U.S. Provisional Patent Application of Gregory Robinson, Ser. No. 61/161,863 for SPRAY-BASED DEGREASING FLUID filed on Mar. 20, 2009.

### BACKGROUND OF THE INVENTION

### Field of the Invention

This patent application relates to a spray-based degreasing fluid containing an exempt volatile organic compound. In particular, it relates to a single component fluid consisting of parachlorobenzotrifluoride applied using a spray application.

Many current grease and oil removers have increasingly been subject to legislative bans and consumer avoidance because these cleaners contain unsafe chemical entities. These chemicals are toxic, carcinogenic, and/or ozone depleters. Indeed, volatile organic compound (VOC) content is increasingly an issue in and throughout North America. As a result, an alternative degreasing agent that has low-toxicity, is non-carcinogenic and is not an ozone depleter is desired. One such alternative is parachlorobenzotrifluoride (PCBTF). This disclosure provides a cleaning composition that is a 100% PCBTF applied via a spray application. The composition may further include a small percentage (0.1 to 2.6%) odor masking agent. Lastly, the composition may further contain up to 25% of organic compounds including VOC exempt compounds as indicated in 40 CFR 51.100.

To alleviate flammability concerns, various additives have been proposed to elevate the flash point of the resultant mixture. U.S. Pat. No. 6,429,176 issued the Chen, et al. presents a blend of a benzotrifluoride with 1,1,2-trichloroethylene (TCE). However, TCE is a carcinogen, thus defeating the purpose of preparing an alternative degreasing agent. U.S. Pat. No. 5,756,002 issued to Chen et al. describes a blend of benzotrifluoride and a fluorocarbon, alkyl perfluoroethers, or fluorochlorocarbons. However, each of these classes of additives has been implicated in various adverse health and/or environmental effects. U.S. Pat. No. 6,020,299 issued to Chen, et al. discloses a single phase fluid comprising a chlorinated benzotrifluoride and a perfluorinated liquid. However, perfluorinated chemicals do not break down in the environment, and they accumulate in the body raising concern for potential environmental contamination and long-term health effects.

To date, as discussed above, PCBTF is used as a degreaser at high concentrations but only in wipe cleaning and dip cleaning applications. There may be spray applications that use PCBTF, but only in low concentrations. These methods are suitable for certain applications, but are infeasible in others—namely the automotive repair/service industry-for example: automotive paints and clear coat used for refinishing. Therefore, it is apparent that there is a need for an application which reduces or eliminates adverse health and environmental impacts, namely through pressurized spray delivery. Spray cleaners containing PCBTF have PCBTF concentrations usually between 10-15% by volume and often contain hazardous volatile organic compounds (VOCs) and/or hazardous air pollutants (HAPs). The relatively low percentage of PCBTF yields a cleaner with decreased degreasing efficiency resulting in the need to use greater amounts of the cleaners, subsequently releasing greater amounts of the hazardous materials in the mixtures. Thus, a spray-based application containing a high percentage by volume of PCBTF is needed and is the subject of the present disclosure.

### SUMMARY OF THE INVENTION

We have discovered that no one has used PCBTF via a pressurized spray application at high concentrations. PCBTF is VOC exempt as stipulated in 40 CFR 51.100 and evaporates quickly, has low toxicity, is non-carcinogenic, is not an ozone depleter, and is rated nonflammable by DOT. Additionally, the degreasing fluid may contain a small percent by volume odor masking agent or agents which possess a similar evaporation rate as PCBTF and does not leave a residue on the cleaned surface following evaporation. Also, a relatively small percentage of additional solvents, such as those indicated in 40 CFR 51.100, or about 5% TCE, may be added to the PCBTF to help minimize cost without adversely affecting degreasing performance and VOC content.

### DESCRIPTION OF SPECIFIC EMBODIMENTS

A preferred embodiment of the present disclosure is a degreasing fluid comprising PCBTF delivered via a spray application. Preferably, the spray application means is an aerosol using carbon dioxide gas as the carrier. However, any suitable carrier gas can be used, such as nitrogen or compressed air. Additional spray application means are also envisioned, including but not limited to pump sprays, trigger sprays, pneumatic sprayers, and high volume low pressure sprayers. Optimally, the degreasing fluid is sprayed in a narrow cone with sufficient pressure to penetrate the grease without damaging the underlying surface. Spray optimization is a function of the type and thickness of the grease deposited on the surface and the type of material comprising the surface. The pressure and overall coverage of the sprayed fluid is variable and controllable by adjusting the distance between the greased surface and the spray nozzle as the fluid is applied. The closer the nozzle to the surface, the greater the pressure but narrower the cone of applied fluid.

In a preferred embodiment, PCBTF comprises 100% of the degreasing fluid. Another preferred embodiment comprises a degreasing fluid composed of greater than about 97.4% PCBTF by volume with the balance comprising at least one odor masking agent. PCBTF has a strong odor. Adding an odor masking agent having about 0.1 to about 2.6% by volume concentration successfully masks the odor. Any fragrance may be used, however, in a preferred embodiment this masking agent possesses a suitable evaporation rate and does not leave a residue on the cleaned surface following evaporation. In an additional preferred embodiment, the degreasing formulation includes the addition of a low weight, volatile organic compound listed in 40 CFR 51.100. This formulation contains about 75 to about 99.9% PCBTF with the low weight organic compound comprising about 0.1 to about 25% of the mixture. Optionally, 0.1 to about 0.5% odor masking agent or agents can further be added to the above formulation. More preferably, the formulation comprises about 90 to about 99.9% PCBTF and about 0.1 to 10% low weight volatile organic compound; additionally about 0.1 to about 2.6% odor masking agent or agents can further be added.

Each of the above formulations is to be applied by a spray application of a preferred embodiment of the present disclosure. In one preferred embodiment, the degreasing formulation is aerosolized in a spray can utilizing an inert gas, such as carbon dioxide, nitrogen, air, or the like as the propellant. In a separate embodiment, the degreasing fluid is stored in a non-pressurized container. This container can be any size, ranging from a small bottle such as one commonly used for household cleaners to a large 55 gallon drum or larger container. No matter the size of the container, a pump or trigger spray mechanism is used to draw the fluid to an atomizer where the fluid is then dispersed in fine droplets onto the soiled surface. Additional embodiments of the present disclosure include pneumatic sprayers and high volume low pressure sprayers wherein the spray vessel is charged with degreasing fluid and then pressurized using an air compressor.

Optimally, the degreasing fluid is sprayed in a narrow cone with sufficient pressure to penetrate the grease without damaging the underlying surface. Spray optimization is a function of the type and thickness of the grease deposited on the surface and the type of material comprising the surface. The pressure and overall coverage of the sprayed fluid is variable and controllable by adjusting the distance between the greased surface and the spray nozzle as the fluid is applied. The closer the nozzle to the surface, the greater the pressure but narrower the cone of applied fluid.

Although the disclosure has been described with reference to certain preferred embodiments, it will be appreciated by those skilled in the art that modifications and variations may be made without departing from the spirit and scope of the disclosure. It should be understood that applicant does not intend to be limited to the particular details described above.

What is claimed is:

1. A composition for degreasing surfaces comprising:
(a) about 97.4 to 100% by volume parachlorobenzotrifluoride; and
(b) 0 to about 2.6% by volume of a masking agent.

2. A composition for degreasing surfaces comprising:
(a) about 75 to about 99.9% by volume parachlorobenzotrifluoride; and
(b) about 0.1 to about 25% by volume at least one organic compound.

3. The composition of claim 2 wherein said at least one organic compound is selected from the group consisting of an alkane from C1-C8, benzene, glycol, alcohols (methanol, ethanol, isopropyl alcohol, etc) xylene, toluene, isoparaffin, Stoddard's solvent, a glycol, mineral spirits, 1,1,2 tricloroethylene, acetone, t-butyl acetate, dimethyl carbonate, and other VOC exempt chemicals as indicated in 40 CFR 51.100.

4. The composition of claim 2 wherein the composition further comprises about 0.1 to about 2.6% by volume at least one odor masking agent.

5. The composition of claim 2 wherein said composition comprises about 5% 1,1,2 trichloroethylene.

6. The composition of claim 2 wherein said composition comprises about 90 to about 99.9% by volume parachlorobenzotrifluoride and about 0.1 to about 10% by volume at least one organic compound.

7. The composition of claim 6 wherein the composition further comprises about 0.1 to about 2.6% by volume at least one odor masking agent.

8. The composition of claim 6 wherein said at least one organic compound is selected from the group consisting of an alkane from C1-C8, benzene, glycol, alcohols (methanol, ethanol, isopropyl alcohol, etc) xylene, toluene, isoparaffin, Stoddard's solvent, a glycol, mineral spirits, 1,1,2 tricloroethylene, acetone, t-butyl acetate, dimethyl carbonate, and other VOC exempt chemicals as indicated in 40 CFR 51.100.

9. The composition of claim 6 wherein said composition comprises about 5% 1,1,2 trichloroethylene.

10. A method for degreasing surfaces comprising:
(a) providing a composition comprising about 97.4 to 100% by volume parachlorobenzotrifluoride and 0 to about 2.6% by volume at least one odor masking agent; and
(b) providing a spray application means for applying said composition.

11. The method of claim 10 wherein said spray application means is an aerosol.

12. The method of claim 10 wherein said spray application means is a pump spray.

13. The method of claim 10 wherein said spray application means is a trigger spray.

14. The method of claim 10 wherein said spray application means is high pressure low volume spray.

15. The method of claim 10 wherein said spray application means is a pneumatic spray.
